(19) United States
(12) Patent Application Publication
(10) Pub. No.: US 2014/0101772 A1
(43) Pub. Date: Apr. 10, 2014

(54) INPUT METHOD, INPUT APPARATUS, AND INPUT PROGRAM

(71) Applicant: PANASONIC CORPORATION, Osaka (JP)

(72) Inventor: Jun ANZAI, Kanagawa (JP)

(73) Assignee: PANASONIC CORPORATION, Osaka (JP)

(21) Appl. No.: 14/041,286

(22) Filed: Sep. 30, 2013

(30) Foreign Application Priority Data
Oct. 5, 2012 (JP) 2012-223417

(51) Int. Cl. G06F 21/60

(52) U.S. Cl. CPC G06F 21/60
USPC 726/26

(57) ABSTRACT

An input apparatus includes an information storage unit which stores identification information of an application or a service and user information such that the identification information and the user information are correlated with each other, an input manipulation detecting unit which detects an input manipulation on an editable region in an image area of the application, a region detecting unit which detects editable regions included in the image area of the application, and a control unit which, if at least one of the detected editable regions includes a first region having a prescribed input attribute for input of first information in the user information, performs a control so that at least part of the user information is input using, as a reference, the first region or the editable region whether the input manipulation is detected.

### BACKGROUND

The present disclosure relates to an input method, an input apparatus, and an input program.

Inputting an ID and a password in using one of various services is a common procedure for securing safety. If the input ID and password coincide with a pre-registered user ID and password, it can be recognized that the person who has input the ID and password is the user having the user ID. For example, such user IDs and passwords are used in websites, applications, and services provided by financial institutions, as well as for identity verification of cellphone users.

Among ID/password input apparatus are portable terminals that are compatible with IC card authentication (refer to JP-A-2008-097210, for example). The portable terminal of JP-A-2008-097210 is equipped with an IC card reader, an information display device, an information storage managing device, and a control means. The information storage managing device stores a URL, an ID, and a password while taking a security measure when a user has logged in to a certain service. When the user logs in to the same service again, the control means searches for the ID and password using its URL, displays them on the information display device, have them confirmed by the user, and enters them.

Among ID/password input programs are input programs which are activated when a password is input to an activation screen (refer to JP-A-2004-259208). The program of JP-A-2004-259208 causes a computer to execute a recording step and an input step. In the recording step, after a password is input to an activation screen, an ID, a password, etc. that are input-requested by an input screen other than the activation screen are input to the input screen and those pieces of input information are stored in a database. At the input step, when the password is input to the activation screen after the above storage of the pieces of input information in the database, the pieces of input information that were input previously and are now stored in the database are input to the input screen every time it is opened.

Furthermore, browsers are known which store an ID and a password in such a manner that they are correlated with a URL and, when the ID or password is input, inputs the stored password or ID.

Neither JP-A-2008-097210 nor JP-A-2004-259208 discloses a specific input method of an ID and a password. In the above-mentioned browsers, an ID and a password are stored in a browser itself. Therefore, information stored in a browser cannot be used for input of an ID and a password to another browser or application. For example, where an SNS (social networking service) application operates independently of the browser, pieces of information stored in each browser cannot be used in it.

The security levels of applications are determined on an application-by-application basis and hence are different from one application to another. Therefore, if security information is managed in an application that is low in security level, the probability of occurrence of stealing or falsification of high-secrecy information such as a password is increased.

### SUMMARY

The present disclosure has been made in the above circumstances, and an object of the present disclosure is to provide an input method, an input apparatus, and an input program which enable input of information while securing a high security level, without depending on the application.

An input method according to the present disclosure is an input method of an input apparatus, the input method comprising:

detecting an input manipulation on an editable region in an image area of an application;

detecting editable regions included in the image area of the application where the input manipulation is detected; and

if at least one of the detected editable regions includes a first region having a prescribed input attribute for input of first information included in user information of a user who uses the application or a service, performing a control so that at least part of the user information, which corresponds to identification information of the application where the input manipulation is detected or the service and which is stored in an information storage unit, is input by using, as a reference, the first region or the editable region whether the input manipulation is detected,

wherein the at least part of the information is stored in the information storage unit such that the identification information of the application or the service and the user information are correlated with each other.

An input apparatus according to the present disclosure comprises:

an information storage unit which stores identification information of an application or a service and user information of a user who uses the application or the service such that the identification information and the user information are correlated with each other;

an input manipulation detecting unit which detects an input manipulation on an editable region in an image area of the application;

a region detecting unit which detects editable regions included in the image area of the application where the input manipulation is detected; and

a control unit which, if at least one of the editable regions detected by the region detecting unit includes a first region having a prescribed input attribute for input of first information included in the user information, performs a control so that at least part of the user information, which corresponds to the identification information of the application where the input manipulation or the service and is stored in the information storage unit, is input using, as a reference, the first region or the editable region whether the input manipulation is detected.

An input program according to the present disclosure is a program for causing a computer to execute the steps of the above input method.

The present disclosure enables input of information while securing a high security level, without depending on the application.

### BRIEF DESCRIPTION OF THE DRAWINGS

FIG. 1 is a block diagram showing an example configuration of the input apparatus according to an embodiment of the present disclosure.

FIG. 2 is a block diagram showing an example detailed functional configuration of the control unit according to the embodiment.

FIG. 3 shows an example format of a registered information DB used in the embodiment.

FIG. 4 shows an example application-independent keyboard used in the embodiment.

FIG. 5 is a conceptual diagram of encryption of an intent which is performed in the embodiment.

FIG. 6 is a flowchart outlining the whole of an example operation of the input apparatus according to the embodiment.

FIG. 7 shows an example screen including a PWM cooperation button used in the embodiment.

FIG. 8 is a conceptual diagram illustrating an example operation which is performed in the embodiment when a tap on a text box is detected.

FIG. 9 is a conceptual diagram illustrating another example operation which is performed in the embodiment when a tap on a text box is detected.

FIG. 10 is a flowchart of an example PW input box check process which is executed in the embodiment.

FIG. 11 is a conceptual diagram of a registered information search process and an automatic input process (mainly the automatic input process) which are executed in the embodiment.

FIG. 12 is a conceptual diagram of the registered information search process and the automatic input process (mainly the registered information search process).

FIG. 13 is a flowchart of an example automatic input process which is executed in the embodiment.

FIGS. 14A-14C illustrate an example focus movement which occurs in the embodiment.

FIG. 15 is a flowchart of an example registered information search process which is executed in the embodiment.

FIG. 16 shows an example input information selection screen used in the embodiment.

FIG. 17 is a flowchart of an example master key setting process which is executed in the embodiment.

FIGS. 18A-18E show example screens that are displayed on a display unit in the master key setting process.

### DETAILED DESCRIPTION OF EXEMPLARY EMBODIMENTS

An embodiment of the present disclosure will be hereinafter described with reference to the drawings. The concept of the embodiment can be applied to apparatus to which input information (e.g., ID and password) is to be input, such as mobile apparatus (e.g., smartphones), PCs, and consumer electronics equipment. The embodiment is directed to a smartphone as an input apparatus.

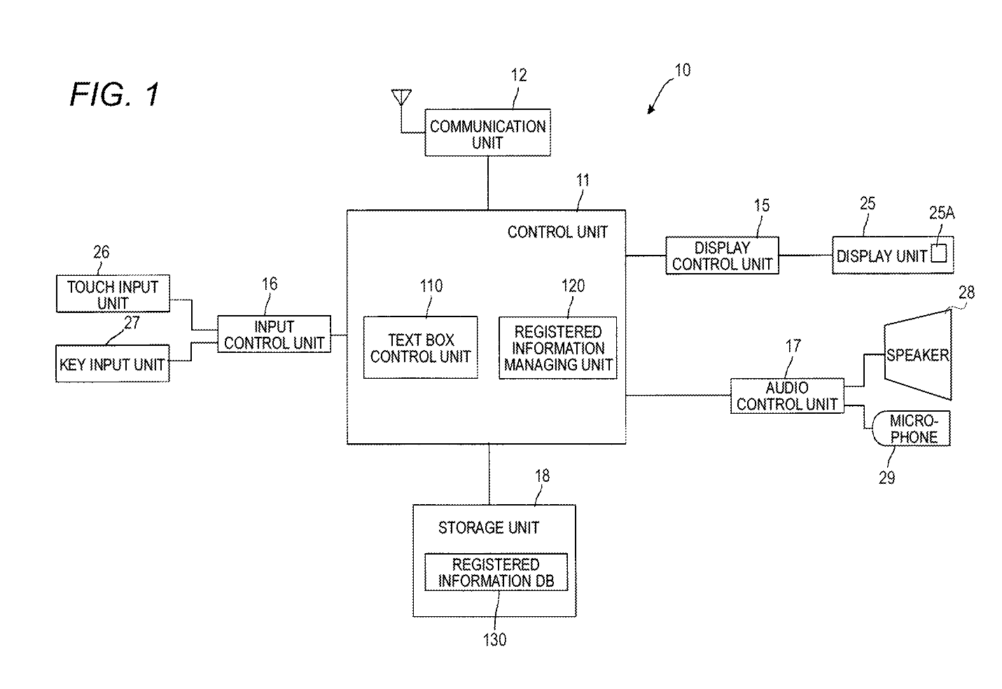

FIG. 1 is a block diagram showing an example configuration of the input apparatus 10 according to the embodiment. The input apparatus 10 is equipped with a control unit 11, a communication unit 12, a display control unit 15, an input control unit 16, an audio control unit 17, a storage unit 18, a display unit 25, a touch input unit 26, a key input unit 27, a speaker 28, and a microphone 29. The storage unit 18 has a registered information DB (database) 130, for example.

The control unit 11 incorporates a known CPU, ROM, and RAM. Various functions of the control unit 11 are realized when the CPU runs control programs stored in the ROM. The control unit 11 includes a text box control unit 110 and a registered information managing unit 120. The control unit 11 also runs applications which include a browser, an SNS application, etc.

The control unit 11 also performs a service (e.g., web service) of an application (e.g., browser). For example, the execution of a service includes execution of a client function of calling a web service and execution of a server function of providing a web service. Although the following description will mainly be directed to execution of an application, the same concept is applicable to execution of a service.

The communication unit 12 makes a connection to a public wireless base station or a wireless LAN (local area network), for example, and performs a communication via an antenna.

The display control unit 15 controls the display unit 25 connected to it. The display unit 25 performs various display operations, and displays an ongoing application, for example, on a screen 25A.

The input control unit 16 controls the touch input unit 26 and the key input unit 27. The touch input unit 26 includes a touch panel which is disposed adjacent to the screen 25A of the display unit 25, and enables various input manipulations (e.g., tap manipulation, drag manipulation, and pinch manipulation). The key input unit 27 enables manipulation of various keys of the input apparatus 10.

The storage unit 18 is stored with various databases (DBs) and various tables. The registered information DB 130 holds information of a user who uses applications or services and pieces of information indicating those applications or services in such a manner that they are correlated with each other. For example, the information of the user includes a user ID (may be referred to simply as ID) and a password (may be abbreviated as PW). The registered information DB 130 will be described later in detail.

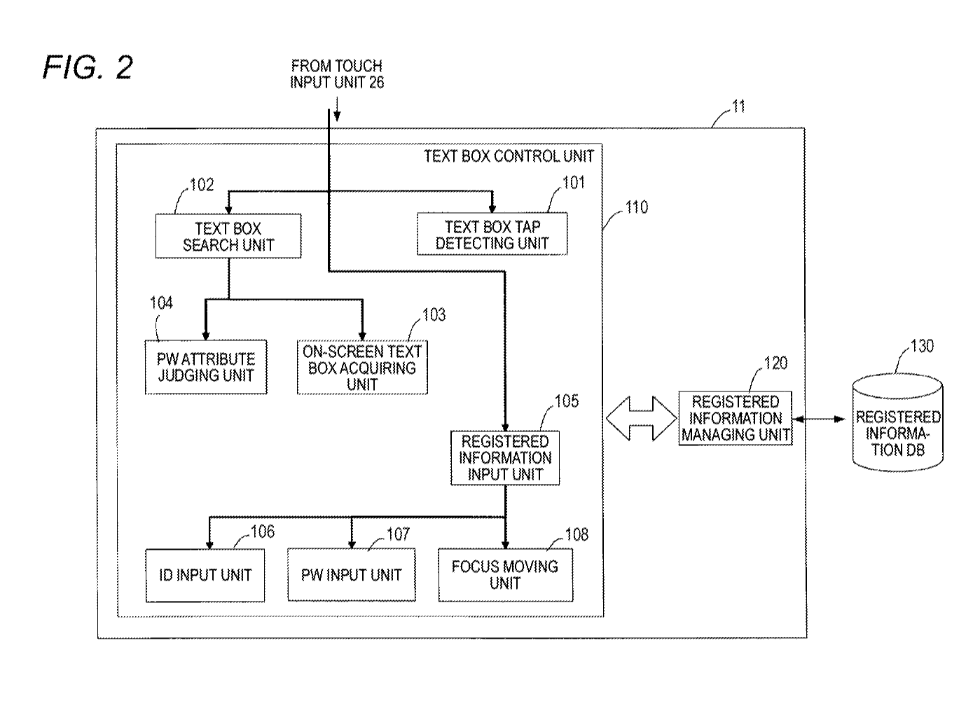

FIG. 2 is a block diagram showing an example detailed functional configuration of the control unit 11. The control unit 11 has the text box control unit 110 and the registered information managing unit 120. The text box control unit 110 functions as an FEP (front end processor) application which is one of keyboard applications. The registered information managing unit 120 functions as a password manager (PWM) for managing a password and other information of the user. The password manager is an application for safely managing pieces of user information (website log-in password, bank personal identification number, etc.) together.

The text box control unit 110 is equipped with a text box tap detecting unit 101, a text box search unit 102, an on-screen text box acquiring unit 103, and a PW attribute judging unit 104. The text box control unit 110 is also equipped with a registered information input unit 105, an ID input unit 106, a PW input unit 107, and a focus moving unit 108.

The text box tap detecting unit 101 detects a touch manipulation that has been made through the touch input unit 26 to an editable text box that is displayed on the screen 25A of the display unit 25. An editable text box is an example editable region. A tap manipulation is an example touch manipulation.

The text box search unit 102 searches for text boxes that exist in a screen (image) displayed on the screen 25A of the display unit 25 when a tap manipulation on a text box is detected by the text box tap detecting unit 101. The on-screen text box acquiring unit 103 acquires the text boxes found by the text box search unit 102.

The PW attribute judging unit 104 judges whether or not the input attribute of each text box acquired by the on-screen text box acquiring unit 103 is an attribute for input of a password (PW attribute). This makes it possible to judge whether or not each acquired text box is for input of a password.

Since passwords basically consist of alphanumeric characters, a text box for input of a password is assigned a particular attribute. Various kinds of information (e.g., names, mail address, telephone number, member's ID number, and other symbols and sentences) are input to text boxes for input of information (e.g., user ID) other than a password. It is therefore difficult to assign particular attributes to such text boxes.

The registered information input unit 105 controls the ID input unit 106, the PW input unit 107, and the focus moving unit 108 to input information of the user of an application being executed. For example, the user information includes an application user ID and password, an address, a date of birth, and other information for identification of the user.

The registered information input unit 105 sends identification information of an application being executed to the registered information managing unit 120. The registered information input unit 105 receives user information corresponding to the application identification information from the registered information managing unit 120.

The ID input unit 106 inputs the user ID received from the registered information managing unit 120 to a prescribed text box (also called an ID input box). The position of the prescribed text box is determined based on the position of the password-input text box as a reference.

A text box for input of a user ID is displayed on the screen 25A adjacent to (e.g., above or on the left of) the password-input text box, according to the application. Therefore, the ID input unit 106 can recognize the prescribed text box on the basis of the application identification information and the position of the password-input text box.

The PW input unit 107 inputs the password received from the registered information managing unit 120 to the password-input text box (also called a PW input box). The password-input text box is a text box that has been judged by the PW attribute judging unit 104 to have a PW attribute among the text boxes acquired by the on-screen text box acquiring unit 103.

The focus moving unit 108 moves the text box on which attention should be focused. That is, the focus moving unit 108 changes the text box as an input or edit target.

The registered information managing unit 120 receives the application identification information from the text box control unit 110, and searches the registered information DB 130 using the received application identification information as a search key. The registered information managing unit 120 extracts user information that is stored so as to be correlated with the application identification information, and sends the extracted user information to the text box control unit 110.

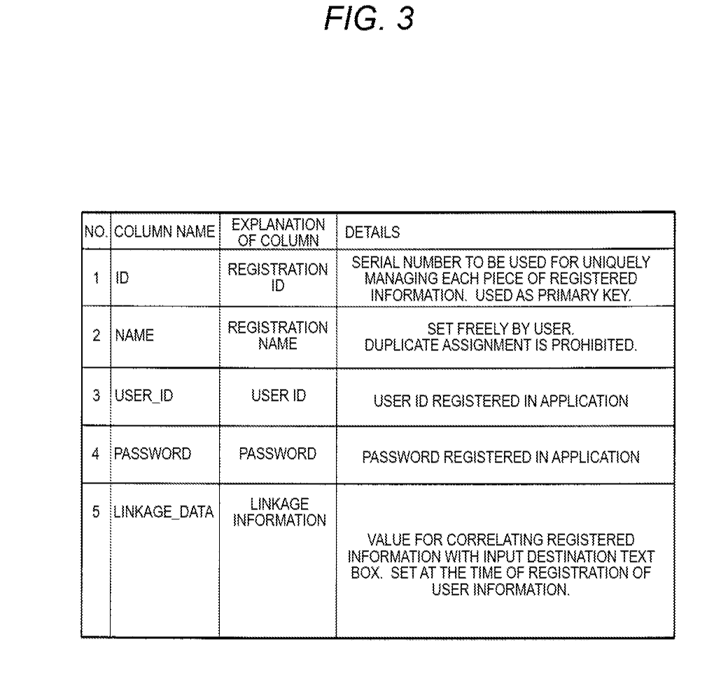

Next, the registered information DB 130 will be described in detail. FIG. 3 shows an example format of the registered information DB 130.

The registered information DB 130 stores a registration ID (ID), a registration name (NAME), a user ID (USER_ID), a password (PASSWORD), and linkage information (LINKAGE_DATA). The terms in parentheses are column names.

The registration ID is identification information to be used for uniquely managing each record (piece of registered information) which is stored in the registered information DB 130. The registration name is set by the user for each record. The user ID is registered in each application. The password is registered in each application.

The linkage information is information for correlating user information with a text box to which prescribed information is to be input, and is, for example, identification information of an application. For example, in the case of an application other than a browser, the linkage information is a component name of an activity having a text box. In the case of a browser, the linkage information is a URL (uniform resource locator) of a page having a text box.

Next, a description will be made of data encryption and decryption which are performed by the input apparatus 10. The input apparatus 10 protects user information from a malicious third party or malware. For example, the input apparatus 10 protects the user information in such processing as registration of user information, storage of user information, and sending of user information from the registered information managing unit 120 to the text box control unit 110.

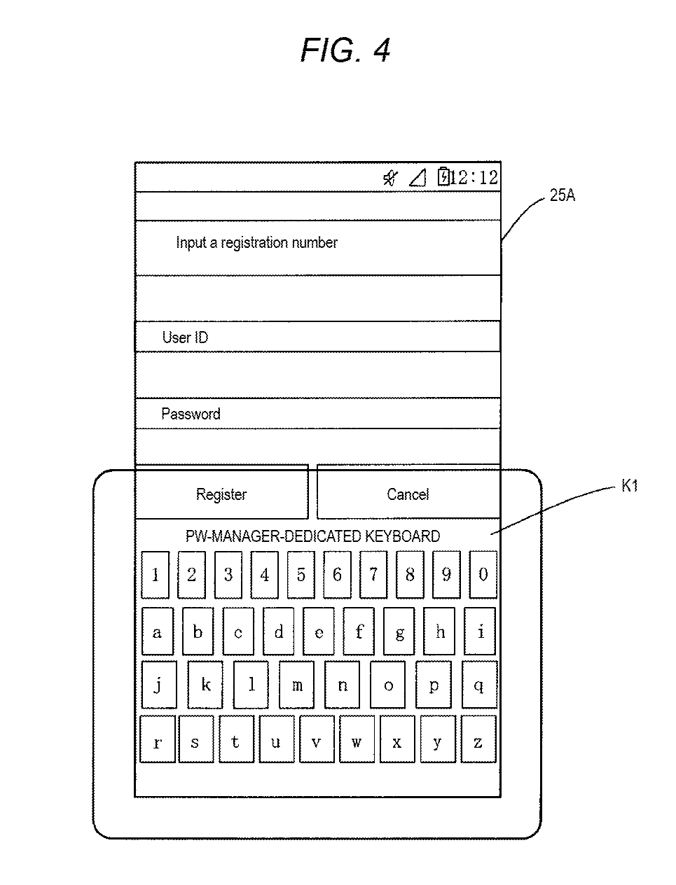

In registration of user information, the registered information managing unit 120 causes display of a keyboard K1 which is held by a password manager. FIG. 4 shows an example of the keyboard K1. The keyboard K1 is independent of an application executed by the control unit 11. Information that has been input through the keyboard K1 is protected from malware, for example, and can thereby be prevented from being stolen by a third party.

When user information is stored, it is registered in the registered information DB 130 after being encrypted. For example, when data is stored in the registered information DB 130, the registered information managing unit 120 encrypts at least a user ID and a password. When encrypted data that is stored in the registered information DB 130 is taken out, the registered information managing unit 120 decrypts it. An example encryption/decryption method is an AES (advanced encryption standard) common key cryptosystem.

When user information is transmitted, a message (e.g., intent) for carrying it is encrypted. The message is used for data transmission between applications (in this example, the FEP application and the password manager).

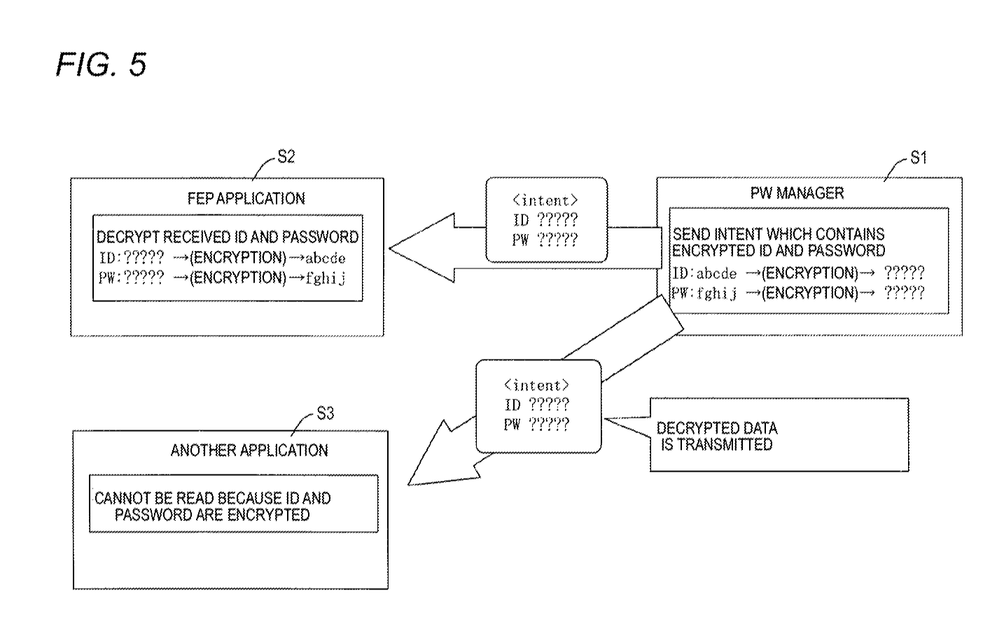

FIG. 5 is a conceptual diagram of encryption of a message. For example, when a message is to be transmitted between the FEP application and the password manager, the registered information managing unit 120 which functions as the password manager encrypts user information contained in the message. When receiving the encrypted user information, the text box control unit 110 which functions as the FEP application decrypts it. Since no applications other than the FEP application can decrypt the user information, it cannot be read by a third party or malware. An example encryption/decryption method is an AES (advanced encryption standard) common key cryptosystem.

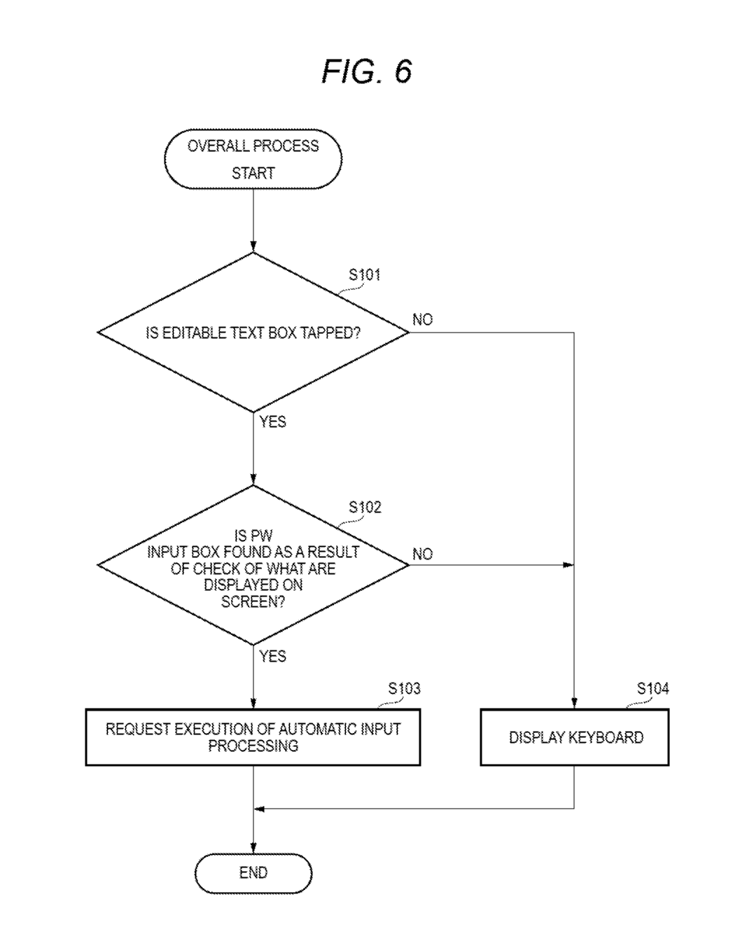

Next, an example operation of the input apparatus 10 will be described. FIG. 6 is a flowchart outlining the whole of an example operation of the input apparatus 10.

First, at step S101, the text box tap detecting unit 101 detects a tap manipulation on the screen 25A of the display unit 25. Furthermore, the text box tap detecting unit 101 whether or not the position of the detected tap manipulation is within any of the regions of text boxes acquired by the on-screen text box acquiring unit 103.

If the tap position is within any of the regions of the text boxes acquired by the on-screen text box acquiring unit 103, at step S102 the PW attribute judging unit 104 judges whether or not those text boxes include a text box having a PW attribute.

If a text box having a PW attribute exists, at step S103 the PW attribute judging unit 104 requests the registered information input unit 105 to perform automatic input processing.

If no text box having a PW attribute exists, the text box control unit 110 finishes the process of FIG. 6.

In the input apparatus 10, user information can be input to a proper text box using, as a reference, a text box having a PW attribute.

If a PW input box exists but no prescribed information is registered in the registered information DB 130, at step S104 the registered information input unit 105 causes an input section (e.g., keyboard K1 shown in FIG. 4) for registration of user information to be displayed on the screen 25A. User information that has been input through the keyboard K1 is registered in the registered information DB 130 via the registered information managing unit 120 together with identification information of an application being executed.

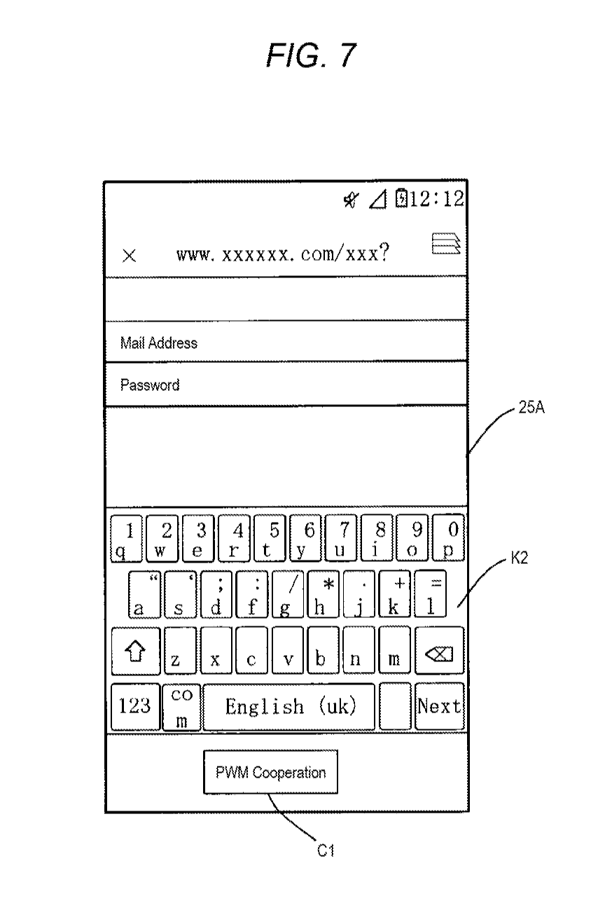

The keyboard K1 may be displayed by the text box control unit 110 or the registered information managing unit 120 after detection of a push of a PWM cooperation button C1 shown in FIG. 7. The PWM cooperation button C1 is a button for starting manual input of user information, that is, starting input of user information without using information stored in the registered information DB 130. Although in FIG. 7 the PWM cooperation button C1 is located at a bottom position of the screen 25A, its display position is not limited to that position.

In FIG. 7, a keyboard K2 is displayed over the PWM cooperation button C1 on the screen 25A. The keyboard K2 is a keyboard which is displayed by the FEP application and is different from the keyboard K1 shown in FIG. 4. The keyboard K1 is higher in security level than the keyboard K2 which is displayed by the FEP application. FIG. 4 shows an example in which a new registration screen is displayed together with the keyboard K1.

Inputting user information using the keyboard K1 prevents important user information (e.g., user ID or password) from being stolen by a key logger.

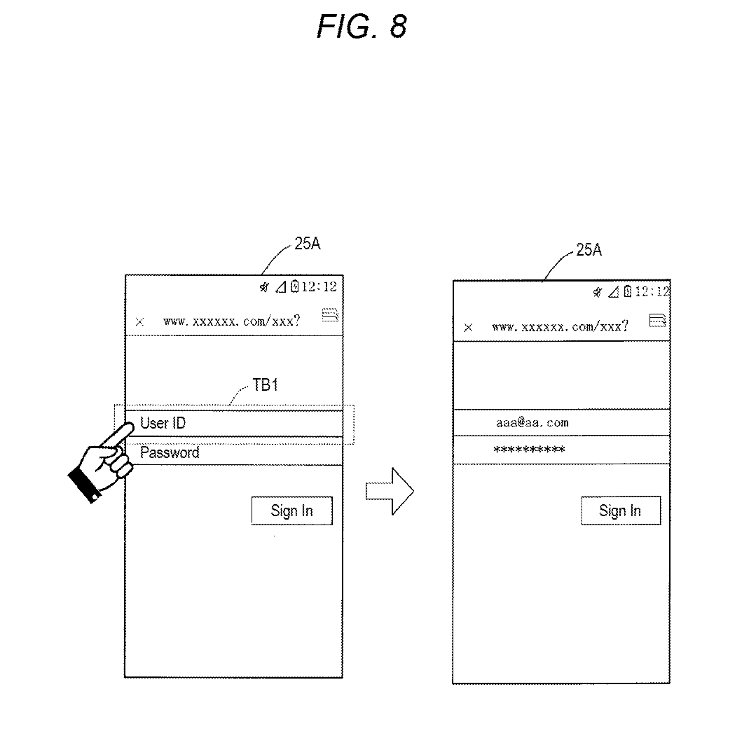

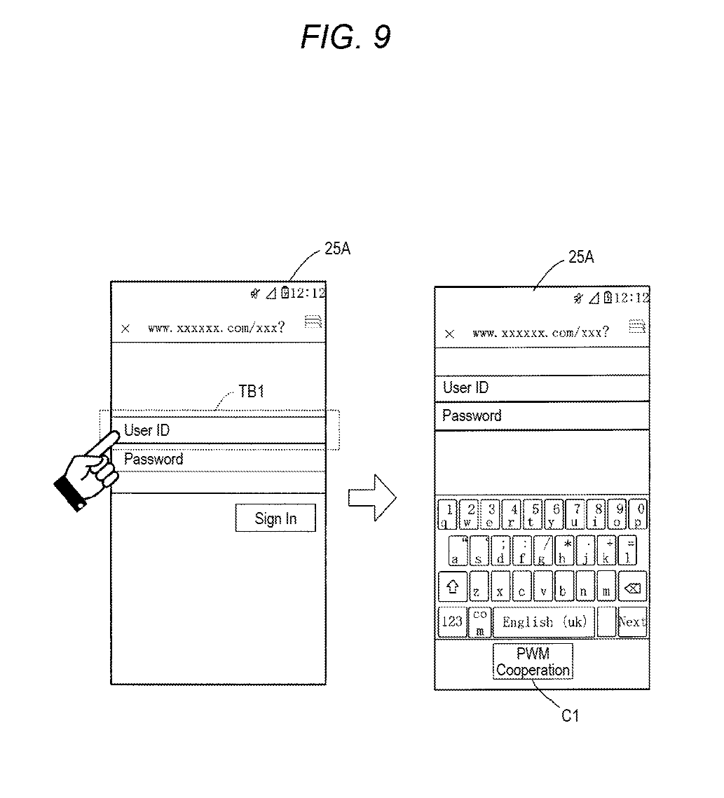

Next, a description will be made of how user information is input by the input apparatus 10. FIGS. 8 and 9 are conceptual diagrams illustrating how the input apparatus 10 operates when a tap on a text box is detected. FIG. 8 shows a case that the same identification information as identification information of an application being executed is contained in a record that is stored in the registered information DB 130. FIG. 9 shows a case that no identification information that is identical to identification information of an application being executed is contained in any record that is stored in the registered information DB 130.

In the case of FIG. 8, when a tap on a text box TB1 (ID input box), a user ID and a password are input by automatic input processing. In the case of FIG. 9, even if a tap on a text box TB1 (ID input box), since user information is not registered, no user ID or password can be input by automatic input processing. In the case of FIG. 9, the PWM cooperation button C1 is displayed which enables manual input of user information. Pushing the PWM cooperation button C1 makes it possible to use the keyboard K1 which is high in security level.

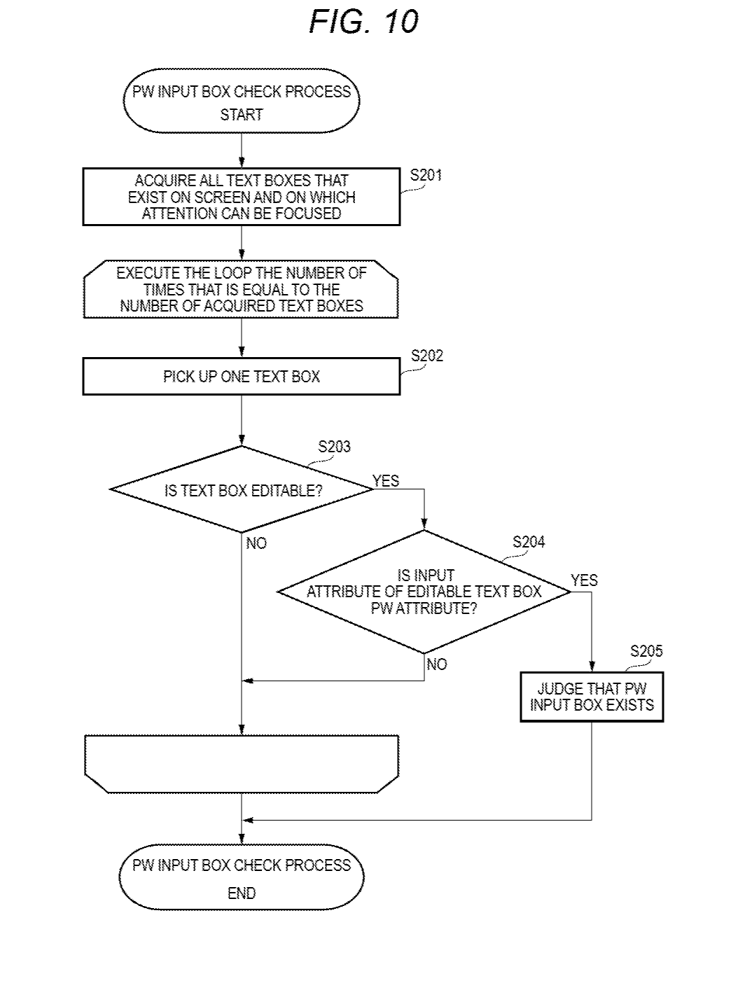

Next, a PW input box check process will be described. FIG. 10 is a flowchart of an example PW input box check process which is a detailed version of steps S101 and S102 shown in FIG. 6.

First, at step S201, the on-screen text box acquiring unit 103 acquires text boxes that exist on the screen 25A of the display unit 25 and on which attention can be focused. Steps S202-S204 are executed repeatedly by the number of times that is equal to the number of acquired text boxes.

At step S202, the PW attribute judging unit 104 picks up one of the acquired text boxes. At step S203, the PW attribute judging unit 104 judges whether or not the picked-up text box is editable.

If the picked-up text box is editable, at step S204 the PW attribute judging unit 104 judges whether or not its input attribute is a PW attribute. For example, the PW attribute judging unit 104 judges whether “INPUT type=“password”” is set or not.

If the picked-up text box is not editable or the input attribute of the editable text box is not a PW attribute, the process returns to step S202, where the next text box is picked up.

If the input attribute is a PW attribute, at step S205 the PW attribute judging unit 104 judges that a PW input box exists on the screen of the application being executed.

This PW input box check process makes it possible to determine a PW input box having a particular input attribute among plural text boxes contained in an application screen.

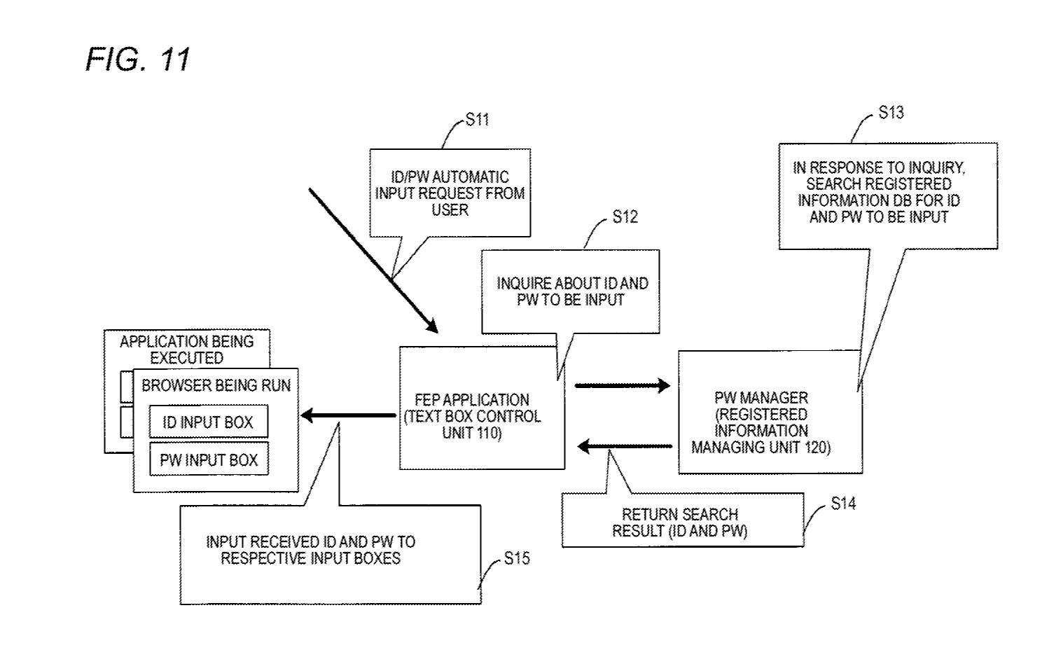

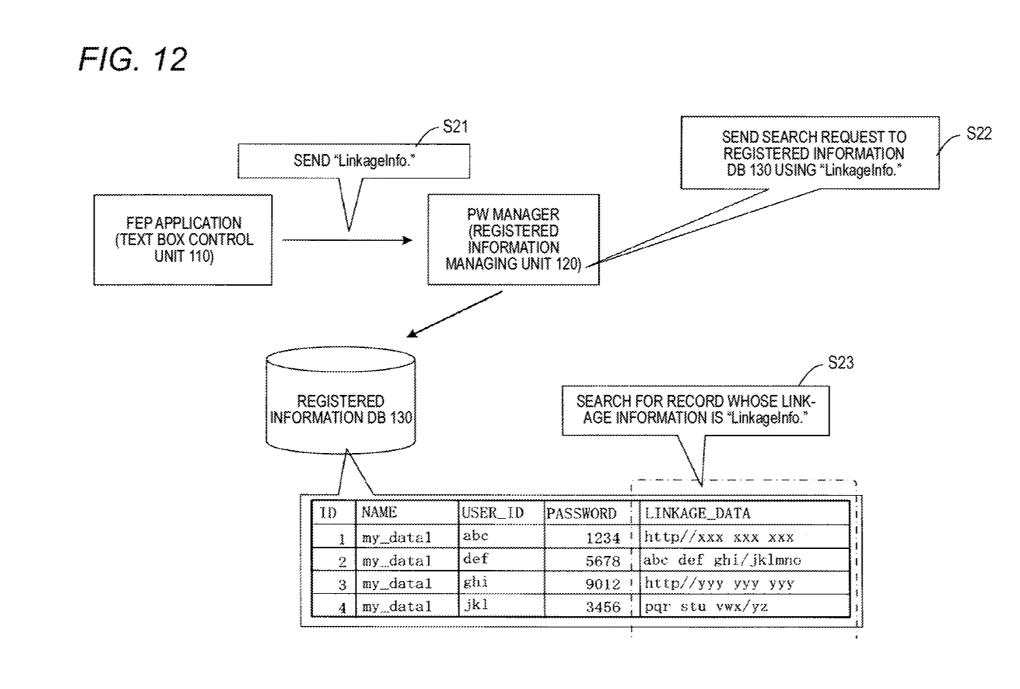

Next, a registered information search process and an automatic input process will be described. FIGS. 11 and 12 are conceptual diagrams of the registered information search process and the automatic input process. The registered information search process and the automatic input process are executed through cooperation between the text box control unit 110 which functions as the FEP application and the registered information managing unit 120 which functions as the password manager.

FIG. 11 mainly shows the automatic input process. FIG. 11 shows a case that user information is a user ID (ID) and a password (PW). The user information necessarily includes user authentication secret information (e.g., password or PIN). Other than a user ID, a mail address or a member's ID number, for example, is assumed as user-related information that is correlated with the user authentication secret information. In the embodiment, no limitations are imposed on the user-related information as long as it relates to the user authentication secret information.

At step S11, the text box control unit 110 receives an automatic input request through the touch input unit 26 or the key input unit 27. Receiving the automatic input request, to input user information, at step S12 the text box control unit 110 inquires of the registered information managing unit 120 about user information.

Receiving the inquiry, the registered information managing unit 120 searches the registered information for input target information at step S13 and returns extracted user information to the text box control unit 110 at step S14.

Receiving the user information, at step S15 the text box control unit 110 inputs the received user information to respective text boxes of an application (including a browser) being executed. For example, the text box control unit 110 inputs a user ID and a password to an ID input box and a PW input box of an application being executed.

FIG. 12 mainly shows the registered information search process. FIG. 12 shows a case that user information is a user ID (ID) and a password (PW).

At step S21, the text box control unit 110 inquires the registered information managing unit 120 about user information. For example, the text box control unit 110 sends “LinkageInfo” to the registered information managing unit 120. “LinkageInfo” is linkage information; for example, identification information of an application being executed by the control unit 11 is inserted into the linkage information.

Receiving the inquiry, at step S22 the registered information managing unit 120 sends a search request to the registered information DB 130 using received “LinkageInfo.” In this example, “LinkageInfo” is used as a search key.

At step S23, the registered information managing unit 120 refers to the registered information DB 130 and searches for a record whose linkage information (LINKAGE_DATA column value) is “LinkageInfo.”

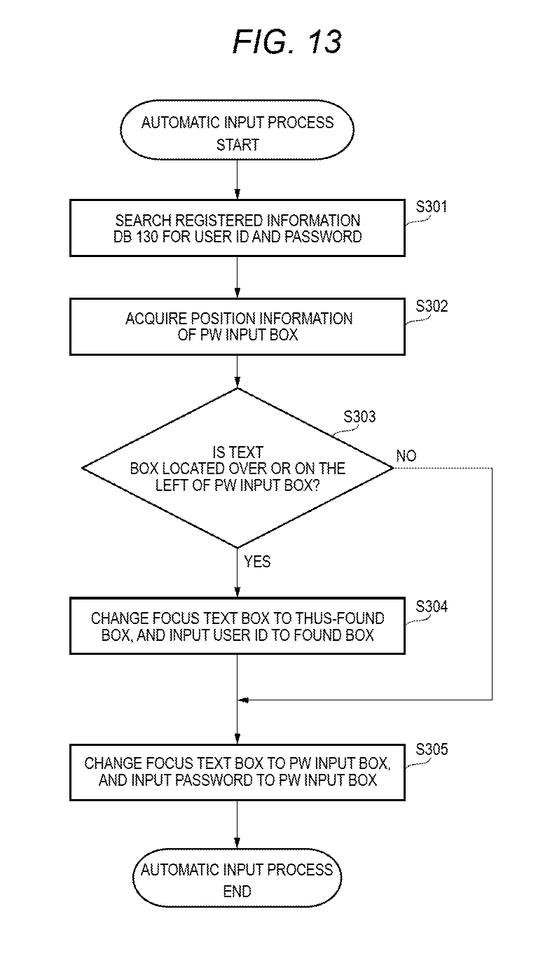

FIG. 13 is a flowchart of an example automatic input process. First, at step S301, the registered information input unit 105 sends identification information of an application being executed to the registered information DB 130 and acquires a user ID and a password.

At step S302, the registered information input unit 105 acquires position information of a text box having a PW attribute (PW input box). For example, pieces of position information are ones indicating relative positions of respective text boxes in an application screen such as order-indicative pieces of information (e.g., information to the effect that the text box is immediately before a PW input box). The position information of a PW input box may be its coordinates in an application screen. The position information of a PW input box varies from one application to another, and is acquired from, for example, the storage unit 18 which is stored with pieces of information of applications. Where a website is displayed by a browser, the position information of a PW input box may be contained in HTML (hypertext markup language) information acquired from a server via the communication unit 12.

At step S303, the registered information input unit 105 judges whether or not a text box exists over or on the left of the PW input box in the application screen.

If a text box exists over or on the left of the PW input box, at step S304 the registered information input unit 105 infers that this text box is an ID input box. The focus moving unit 108 changes the focus text box to the inferential ID input box. The ID input unit 106 inputs the user ID received from the registered information DB 130 to the inferential ID input box.

After the input of the user ID or if it is judged that no text box exists over or on the left of the PW input box, at step S305 the focus moving unit 108 changes the focus text box to the PW input box. The PW input unit 107 inputs the password received from the registered information DB 130 to the PW input box.

Alternatively, the input apparatus 10 may execute another example automatic input process described below. First, the registered information input unit 105 executes steps S301 and S302 shown in FIG. 13.

The registered information input unit 105 then judges whether or not each of all text boxes in the application screen is a PW input box. If it is judged that every text box includes a PW input box, the ID input unit 106 inputs the user ID received from the registered information DB 130 to a first-tapped text box among text boxes in the application screen that are not a PW input box.

After the input of the user ID, the focus moving unit 108 changes the focus text box to the next text box. If this text box is a PW input box, the PW input unit 107 inputs the password received from the registered information DB 130 to it.

This automatic input process makes it possible to input a user ID and a password to respective prescribed input boxes in this order.

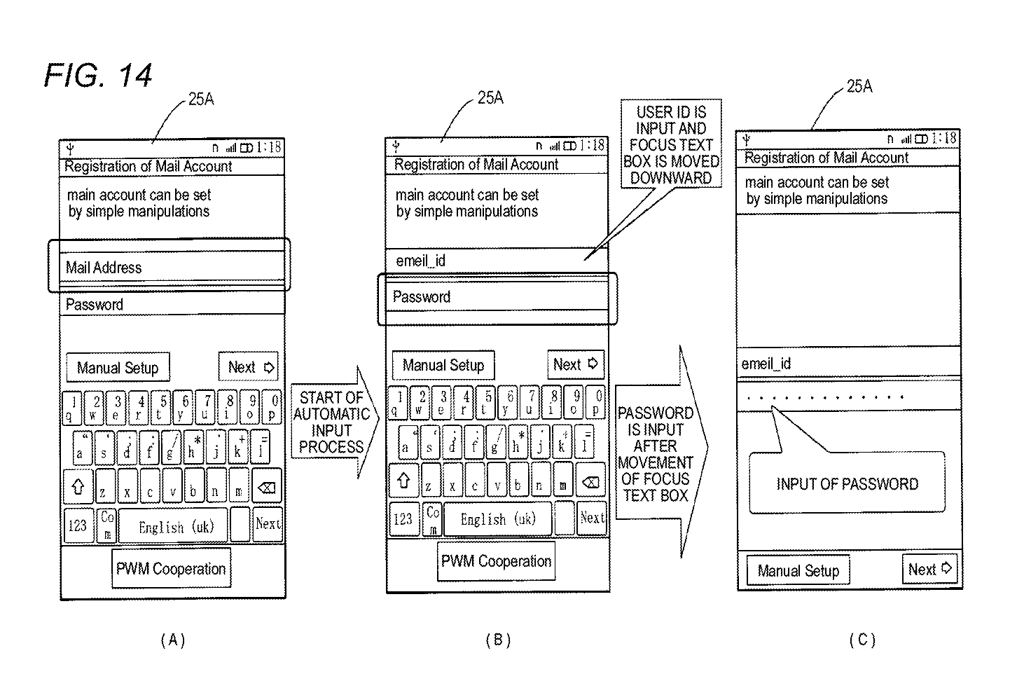

FIGS. 14A-14C shows an example focus movement. The text box control unit 110 inputs a character string, for example, to one focus text box. In the automatic input process, text boxes to which input should be made are a PW input box and an ID input box, for example. When input to one prescribed text box has been finished, the focus moving unit 108 switches to the next text box, which is a focus movement. The edit target text box is changed to the focus text box.

As shown in FIG. 14A, the ID input unit 106 inputs a mail address to the ID input box as a user ID. As shown in FIG. 14B, the focus moving unit 108 changes the focus text box from the ID input box to the PW input box (focus movement). As shown in FIG. 14C, the PW input unit 107 inputs a password to the PW input box which is the focus text box.

If a character string has already been input to a text box before execution of the process of FIG. 13, the registered information input unit 105 may perform a control so as to input user information after deleting the character string already input.

The above-described automatic input process can be executed for not only a text box tapped by the user but also a PW input box (if it exists in an application screen). The positional relationship between an ID input box and a PW input box is predetermined in each application. For example, the registered information input unit 105 recognizes, from an application being executed, that as shown in FIGS. 14A-14C the ID input box is disposed as an editable text box immediately over the PW input box. As a result, even information (e.g., user ID) can be input properly to even a text box whose input attribute is difficult to predetermine (e.g., ID input box). If it is expected that the user will tap the ID input box first, handling of position information of the PW input box can be omitted by inputting a user ID to a first-tapped text box and inputting a password to the next text box.

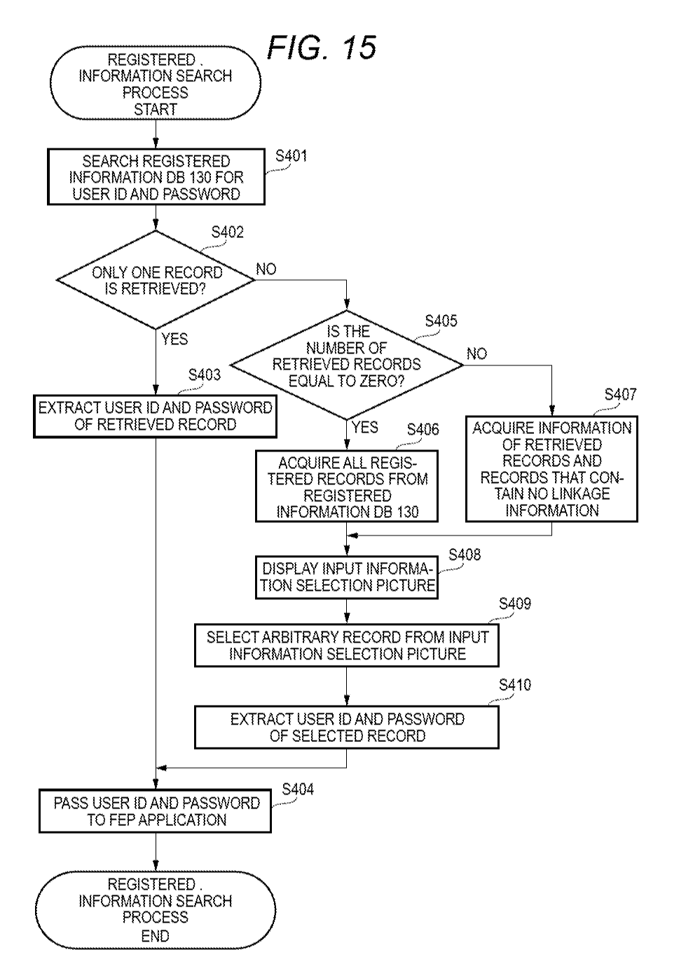

FIG. 15 is a flowchart of an example registered information search process. In the registered information search process, the registered information DB 130 is searched for information of the user who uses an application. FIG. 15 shows a case that user information is a user ID and a password.

First, at step S401, the registered information managing unit 120 searches the registered information DB 130 for user information using, as a search key, identification information of an application received from the registered information input unit 105 of the text box control unit 110. The registered information managing unit 120 judges whether or not the identification information of the application (search key) coincides with the linkage information of a record (registered information) stored in the registered information DB 130. If coincidence is found, the registered information managing unit 120 retrieves that record.

At step S402, the registered information managing unit 120 judges whether or not only one record has been retrieved. If only one record has been retrieved, at step S403 the registered information managing unit 120 extracts the user information of the retrieved record. At step S404, the registered information managing unit 120 sends the extracted user information to the text box control unit 110 which functions as the FEP application.

If the number of records retrieved at step S402 is not equal to one, at step S405 the registered information managing unit 120 judges whether or not the number is equal to zero.

If the number of retrieved records is equal to zero, at step S406 the registered information managing unit 120 acquires information of all the registered records. The number of retrieved records being equal to zero means, for example, that no information that coincides with the application identification information supplied from the text box control unit 110 is stored in the registered information DB 130. Instead of information of all the registered records, information of records that contain no linkage information may be acquired.

If the number of retrieved records is not equal to zero, that is, it is more than or equal to two, at step S407, the registered information managing unit 120 acquires information of the retrieved records and records that contain no linkage information.

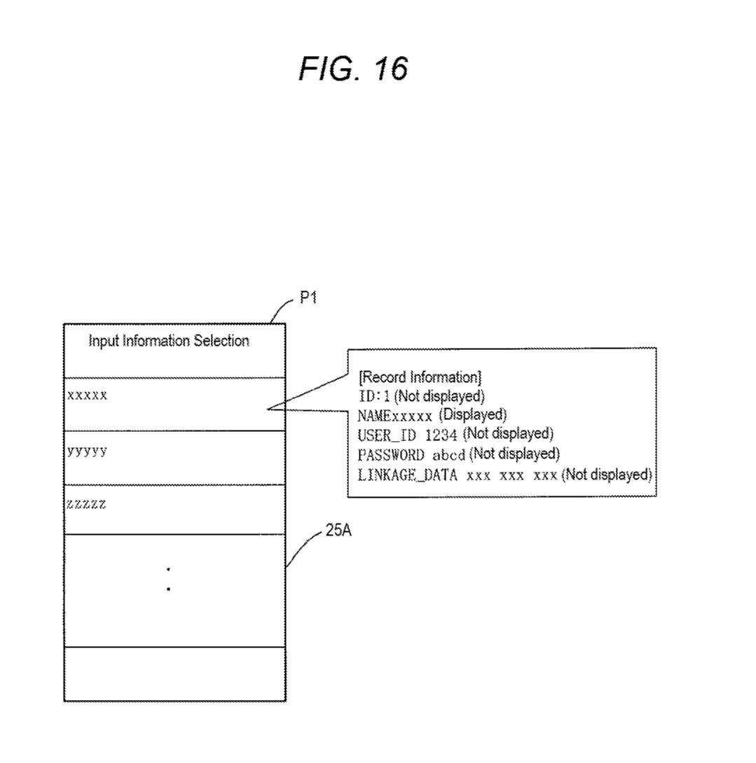

If information of the records was acquired at step S406 or S407, at step S408 the registered information managing unit 120 instructs the display control unit 15 to display an input information selection screen P1 on the display unit 25. The input information selection screen P1 is a screen for selection of user information to be input to editable text boxes. FIG. 16 shows an example input information selection screen P1. For example, the registration names (NAME's) of display subject records are displayed in order in the input information selection screen P1.

At step S409, the registered information managing unit 120 receives, from the input control unit 16, information that has been input through the touch input unit 26 or the key input unit 27 and recognizes an arbitrary record selected from the records being displayed in the input information selection screen P1.

At step S410, the registered information managing unit 120 extracts the user information of the selected record.

At step S404, the registered information managing unit 120 sends the extracted user information to the text box control unit 110 which functions as the FEP application.

The registered information search function makes it possible to acquire user information that relates to an application being executed. Even if it is judged that no information relating to an application being executed is registered in the registered information DB 130, that is, even if no record is retrieved, user information that the user should input can be extracted from a record that does not relate to the application being executed. Therefore, proper information can be extracted easily even in, for example, a case that the URL of a website or the component name of an application was changed.

Even if plural records have been retrieved, user information that the user should input can be extracted easily from the plural records or other records.

Therefore, proper information can be extracted easily even in, for example, a case that the user ID or password was updated or two or more records were registered for a certain application.

When the number of retrieved records is equal to zero, the registered information managing unit 120 may display the keyboard K1 shown in FIG. 4 instead of input information selection screen P1. The keyboard K1 may be displayed after detection of a push of the PWM cooperation button shown in FIG. 7.

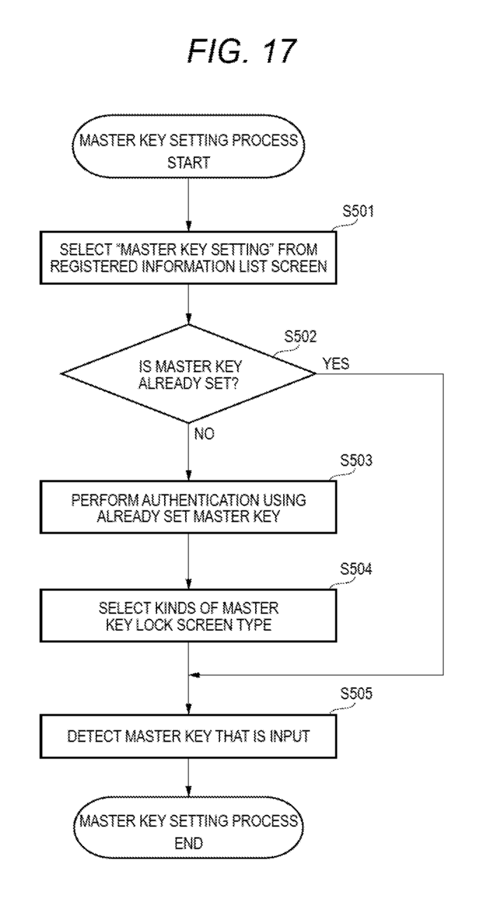

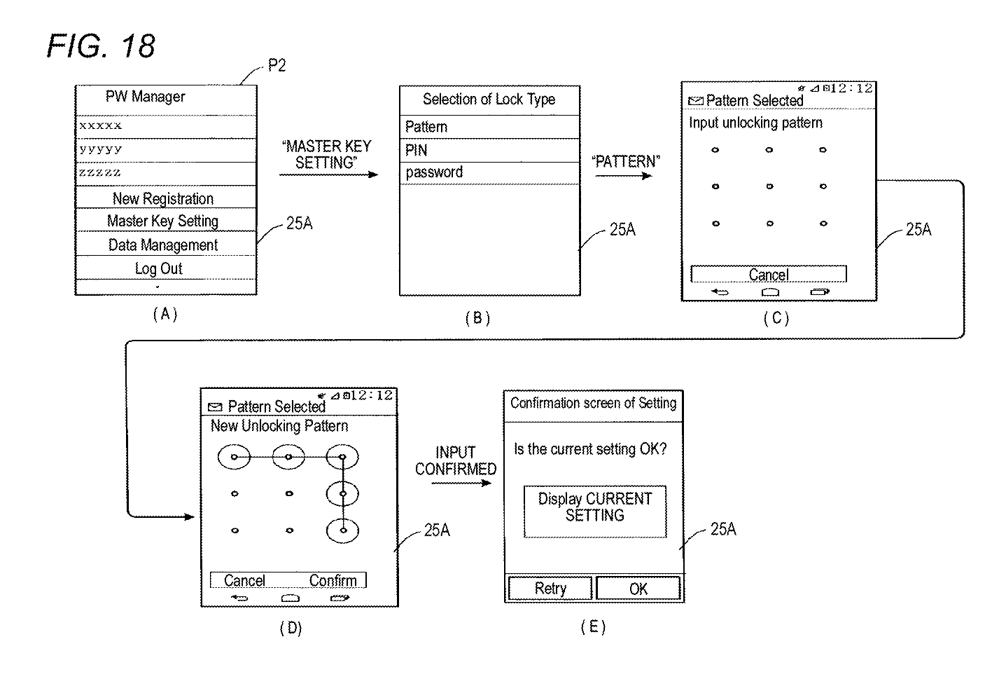

Next, a master key setting process will be described. FIG. 17 is a flowchart of an example master key setting process. The master key is a key for protecting the information stored in the registered information DB 130. The master key is used in using the function of the password manager. FIGS. 18A-18E show example screens that are displayed on the display unit 25 in the master key setting process.

First, at step S501, as shown in FIG. 18A, the control unit 11 selects an item “master key setting” from a registered information list screen P2 in response to an input made through the touch input unit 26 or the key input unit 27.

At step S502, the control unit 11 judges whether a master key has already been set or not. Master key information is stored in the storage unit 18 when set. Therefore, the control unit 11 judges whether or not master key information is stored in the storage unit 18.

If a master key has already been set, at step S503 the control unit 11 performs authentication using the already set master key. For example, the control unit 11 judges that the authentication is successful if a master key pattern that is input through the touch input unit 26 or the key input unit 27 coincides with the already set master key pattern. On the other hand, if the two patterns do not coincide with each other, the control unit 11 judges that the authentication has failed.

If the authentication has succeeded, at step S504 the control unit 11 displays master key lock types on the screen 25A of the display unit 25 (see FIG. 18B). For example, the master key lock types include a pattern, a PIN (personal identification number), and a password. For example, the pattern is information of an input locus on the screen 25A and includes a nine-point lock pattern. The control unit 11 selects an arbitrary lock type in response to an input made through the touch input unit 26 or the key input unit 27. It is assumed here that an item “pattern” has been selected as shown in FIG. 18C.

When a lock type was selected at step S504 or if it was judged at step S502 that a master key had not been set yet, at step S505 the control unit 11 detects an arbitrary master key pattern that is input through the touch input unit 26 or the key input unit 27 (see FIG. 18D). The pattern thus input is confirmed as shown in FIG. 18E and then registered in the storage unit 18.

The master key setting process makes it possible to set a master key of a desired type. Since the PW manager is made usable after setting and authentication of a master key, various passwords of respective applications can be input by the automatic input process merely by remembering only one password.

In the above master key setting process, the item “master key setting” is selected from the registered information list screen P2. Master key setting may be performed on another occasion such as first activation of the PW manager.

As described above, the input apparatus 10 is equipped with an information storage unit, an input manipulation detecting unit, a region detecting unit, and the control unit 11. The information storage unit stores identification information of each application or service and information of a user who uses the application or service in such a manner that they are correlated with each other. The input manipulation detecting unit detects an input manipulation on an editable region in a screen of an application. The region detecting unit detects editable regions in the input-manipulation-detected screen of the application. If the editable regions detected by the region detecting unit include a first region having a prescribed input attribute for input of first information included in the user information, the control unit 11 performs a control so that at least part of user information that corresponds to identification information of the input-manipulation-detected application or service and is stored in the information storage unit is input using, as a reference, the first region or an editable region for which an input manipulation has been detected first.

The information storage unit is the storage unit 18, for example. The input manipulation detecting unit is the text box tap detecting unit 101, for example. The region detecting unit is the text box search unit 102, for example. The input manipulation is a tap manipulation, for example. The first information is a password, for example. The prescribed input attribute is a PW attribute, for example. The first region is a PW input box, for example.

The input apparatus 10 makes it possible to easily input user information on the basis of the information stored in the information storage unit using, as a reference, an editable region having a prescribed input attribute. User information can also be input easily to not only the first region having the prescribed input attribute but also another editable region for which it is difficult to set a particular input attribute. Furthermore, user information can be input easily also in, for example, a case of logging in a web service using a browser.

Since the input apparatus 10 itself is provided, independently of applications, with a database for management of pieces of user information of the respective applications, the pieces of user information can be managed independently of the applications. Since the database is independent of the applications, the security can be kept at a certain level without being affected by the security level of each application.

The user information may include the first information and second information. The control unit 11 may perform a control on the basis of a positional relationship between the first region and a second region which is included in the editable regions so that the first information is input to the first region and the second information is input to the second region. The second information is a user ID, for example. The second region is an ID input box, for example. With this measure, plural kinds of user information can easily be input to proper editable regions.

If the detected editable regions include a first region, the control unit 11 may perform a control so that second information is input to an editable region that is not the first region and is one on which an input manipulation has been detected first. And the control unit 11 may perform a control so that the first information is input to the first region for which an input manipulation has been detected first after the input of the second information. With these measures, a user ID and a password, for example, can easily be input to proper editable regions in this order.

If identification information of the input-manipulation-detected application or service is not stored in the information storage unit, the control unit 11 may perform a control so that an input section which is independent of the application and serves for input of user information is displayed. The input section is the keyboard K1, for example. When identification information of the above application or service is not stored in the information storage unit, user information can be registered using the input section which is high in security level.

If identification information of the input-manipulation-detected application or service is not stored in the information storage unit, the control unit may perform a control so that user information that is stored in the information storage unit and to which no identification information of an application or service is correlated is selected and at least part of it is input. For example, such selection and input of user information is done using the input information selection screen P1 in the case where the number of retrieved records is equal to zero. With this measure, when identification information of the above application or service is not stored in the information storage unit, user information can be set easily through selection from a screen.

If user information is not stored in the information storage unit, the control unit 11 may perform a control so that an input section which is independent of the application and serves for input of information for management of the information storage unit is displayed. The input section is the keyboard K1, for example. The information for management of the information storage unit is a master key, for example. With this measure, at the time of first registration when user information has not been registered yet, a master key can be registered using an input section that is high in security level.

The present disclosure is not limited to the above embodiment, and can be applied to any configuration as long as it can realize the functions described in the claims or the functions of the embodiment.

In the embodiment, pieces of information of respective records stored in the registered information DB 130 may be sent out or input to an external storage device (e.g., SD card). This allows an external apparatus to automatically input user information of each application.

In the embodiment, pieces of information that are stored in an external apparatus and correspond to respective record to be stored in the registered information DB 130 may be transmitted and received or input from an external storage device (e.g., SD card). This makes it possible to acquire pieces of user information of respective applications accumulated in the external apparatus and to automatically input user information of each application.

Although the embodiment mainly assumes that user authentication is performed using a master key, user authentication may be performed by another method (e.g., fingerprint authentication).

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2012-223417 filed on Oct. 5, 2012, the contents of which are incorporated herein by reference.

The present disclosure is useful when applied to input methods, input apparatus, and input programs which enable input of information while securing a high security level, without depending on the application.

What is claimed is:

1. An input method of an input apparatus, comprising:
detecting an input manipulation on an editable region in an image area of an application;
detecting editable regions included in the image area of the application where the input manipulation is detected; and
if at least one of the detected editable regions includes a first region having a prescribed input attribute for input of first information included in user information of a user who uses the application or a service, performing a control so that at least part of the user information, which corresponds to identification information of the application where the input manipulation is detected or the service and which is stored in an information storage unit, is input by using, as a reference, the first region or the editable region whether the input manipulation is detected,
wherein the at least part of the information is stored in the information storage unit such that the identification information of the application or the service and the user information are correlated with each other.

2. The input method according to claim 1, wherein the user information includes the first information and second information; and
wherein the control performing step performs the control on the basis of a positional relationship between the first region and a second region which is included in at least one of the editable regions so that the first information is input to the first region and the second information is input to the second region.

3. The input method according to claim 1, wherein the user information includes the first information and second information; and
wherein if the at least one of the detected editable regions includes the first region, the control performing step performs the control so that the second information is input to the editable region other than the first region where the input manipulation is detected and the first information is input to the first region where the input manipulation is detected after the input of the second information.

4. The input method according to claim 1, wherein if the identification information of the application where the input manipulation is detected or the service is not stored in the information storage unit, the control performing step performs the control so that an input section, which is independent of the application and serves for input of the user information, is displayed.

5. The input method according to claim 1, wherein if the identification information of the application where the input manipulation is detected or the service is not stored in the information storage unit, the control performing step performs the control so that user information, which is stored in the information storage unit and to which the identification information of the application or the service is not correlated, is selected and input.

6. The input method according to claim 1, wherein if the user information is not stored in the information storage unit, the control performing step performs the control so that an input section, which is independent of the application and serves for input of information for managing the information storage unit, is displayed.

7. The input method according to claim 1, wherein the first information includes password information of the user.

8. The input method according to claim 2, wherein the second information includes ID information of the user.

9. The input method according to claim 1, wherein the editable regions include text boxes.

10. An input apparatus comprising:
an information storage unit which stores identification information of an application or a service and user information of a user who uses the application or the service such that the identification information and the user information are correlated with each other;
an input manipulation detecting unit which detects an input manipulation on an editable region in an image area of the application;
a region detecting unit which detects editable regions included in the image area of the application where the input manipulation is detected; and
a control unit which, if at least one of the editable regions detected by the region detecting unit includes a first region having a prescribed input attribute for input of first information included in the user information, performs a control so that at least part of the user information, which corresponds to the identification information of the application where the input manipulation or the service and is stored in the information storage unit, is input using, as a reference, the first region or the editable region whether the input manipulation is detected.

11. The input apparatus according to claim 10, wherein the user information includes the first information and second information; and
wherein the control unit performs the control on the basis of a positional relationship between the first region and a second region which is included in at least one of the editable regions so that the first information is input to the first region and the second information is input to the second region.

12. The input apparatus according to claim 10, wherein the user information includes the first information and second information; and
wherein if at least one of the editable regions detected by the region detecting unit includes the first region, the control unit performs the control so that the second information is input to the editable region other than the first region where the input manipulation is detected and the first information is input to the first region where the input manipulation is detected after the input of the second information.

13. The input apparatus according to claim 10, wherein if the identification information of the application where the input manipulation is detected or the service is not stored in the information storage unit, the control unit performs the control so that an input section, which is independent of the application and serves for input of the user information, is displayed.

14. The input apparatus according to claim 10, wherein if the identification information of the application where the input manipulation is detected or the service is not stored in the information storage unit, the control unit performs the control so that user information, which is stored in the information storage unit and to which the identification information of the application or the service is not correlated, is selected and input.

15. The input apparatus according to claim 10, wherein if the user information is not stored in the information storage unit, the control unit performs the control so that an input section, which is independent of the application and serves for input of information for managing the information storage unit, is displayed.

16. The input apparatus according to claim 10, wherein the first information includes password information of the user.

17. The input apparatus according to claim 10, wherein the second information includes ID information of the user.

18. The input apparatus according to claim 10, wherein the editable regions include text boxes.

19. An input program for causing a computer to execute the steps of the input method according to claim 11.
